(19) United States
(12) Patent Application Publication
(10) Pub. No.: US 2026/0218331 A1
(43) Pub. Date: Jul. 30, 2026

(54) PROCESS FOR LEACHING COPPER PRODUCED FROM SECONDARY SOURCES

(71) Applicant: Glencore Technology Pty Limited, Brisbane (AU)

(72) Inventors: Stuart Nicol, Brisbane (AU); Sarah Dowling, Brisbane (AU)

(21) Appl. No.: 19/084,625

(22) Filed: Mar. 19, 2025

(30) Foreign Application Priority Data
Jan. 29, 2025 (AU) 2025900234

(51) Int. Cl. C22B 15/00; C22B 7/00; C25C 1/12

(52) U.S. Cl. CPC C22B 15/0071; C22B 7/007; C22B 15/0069; C22B 15/0073; C25C 1/12

(57) ABSTRACT

The present invention relates to a leaching process. In particular, the present invention relates to a leaching process for copper-containing material from the smelting of one or more secondary copper materials, or “black copper”. More particularly, the present invention relates to a black copper leaching process under acidic and oxidising conditions.

### FIELD OF THE INVENTION

The present invention relates to a leaching process. In particular, the present invention relates to a leaching process for copper-containing material from the smelting of one or more secondary copper materials, or black copper. However, it will be appreciated that the invention is not limited to these particular fields of use.

### BACKGROUND OF THE INVENTION

Any discussion of the prior art throughout the specification should in no way be considered as an admission that such prior art is widely known or forms part of common general knowledge in the field.

Valuable metals are mined from their constituent ores at an exponentially increasing rate. With the overall supply being strictly finite, some metals are already under supply and sustainability pressure. Without increased adoption of recycling practices, the global supply of certain metals will inevitably extinguish long before consumer demand subsides. Examples of such metals include copper, nickel, manganese, cobalt and lithium. As such, it may be desirable to recycle secondary materials, for example E-waste and scraps, to recover these valuable metals.

An example of the current practice of processing secondary copper includes processing the secondary copper in a number of stages of smelting. These stages include: 1) reductive smelting of the secondary copper materials to produce black copper; 2) converting the black copper to produce a raw copper and a slag (for example, a tin slag) in a converting furnace; 3) refining the raw copper to produce anode copper in an anode furnace; 4) smelting the slag (for example, a tin slag) from the converting furnace to produce a metal (for example, tin) product and recycled materials. The anode copper produced by the anode furnace may be processed further using electrorefining to thereby produce copper cathode and precious metal rich slimes. The slimes may be subjected to precious metal refining to produce precious metal products.

There are a number of challenges associated with the process as described above, including: 1) the process, especially the electrorefinery, may not be economically viable unless the copper production rate is above 100,000 tonnes per year. However, most secondary copper recycling projects have capacity of less than 25,000 tonnes of copper per year; 2) lots of furnaces and equipment are involved in the process, which requires significant capital expenditure and skill when operating the process; 3) there is a lot of metal ‘locked-up’ in the smelter and refinery. It takes a long time for the feed materials to be processed into their final products.

A number of processes for treating mineral-containing materials, such as mineral ores and concentrates, involve leaching the materials under conditions such that desired metals go into solution. The solution is then separated from a solid residue and the solution is treated to recover the desired metal from solution. In some instances, some valuable metals or other components remain with the solid residue and it can be desirable to further treat the solid residue from the leaching step to recover valuable metals therefrom.

U.S. Pat. No. 2,031,299, to American Smelting and Refining Co, describes a method of treating anode mud produced in the electrolytic refining of copper which comprises agitating said mud in previously untreated condition with copper refining electrolyte in the presence of air and a small quantity of iron sulphate.

U.S. Pat. No. 11,447,846, to Beijing University of Technology, describes multi-metal products recovery technology from pyrolytic waste integrated circuit boards. In particular, the method involves use of melting and blending, atomization, acidolysis and other technologies to recover multi-metal materials obtained from pyrolytic waste integrated circuit boards and use the heat and oxygen of the atomization process.

WO 2023/243878 A1, to Korea Zinc Co., Ltd, describes a method for leaching valuable metals, particularly copper, contained in raw materials using a pressure leaching method.

It is an object of the present invention to overcome or ameliorate at least one of the disadvantages of the prior art, or to provide a useful alternative.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Although the invention will be described with reference to specific examples it will be appreciated by those skilled in the art that the invention may be embodied in many other forms.

### SUMMARY OF THE INVENTION

According to a first aspect of the invention there is provided a method of copper leaching, comprising the steps of:
a. obtaining a copper-containing material from the smelting of one or more secondary copper materials;
b. subjecting the copper-containing material to an acidic and oxidising leaching medium over a predetermined period, at a predetermined temperature and a predetermined pressure;
c. obtaining a leach residue comprising un-leached metals and/or metal-containing compounds and a copper-containing leachate solution; and
d. recovering copper from the leachate solution.

Advantageously, the leaching of the copper-containing material from the smelting of one or more secondary copper materials removes the need to perform converting and refining of the copper.

In some embodiments, the method further comprises a step of atomising or granulating the copper-containing material after the step a and before step b.

In some embodiments, the copper-containing material has a P₈₀ particle size of about 5 to about 400,000 μm, for example, about 5 μm to about 100 μm, about 100 μm to about 500 μm, about 500 μm to about 1000 μm, about 1000 μm to about 2000 μm, about 2000 μm to about 3,000 μm, about 3000 μm to about 4000 μm, about 4000 μm to about 5000 μm, about 5000 μm to about 10,000 μm, about 10,000 μm to about 50,000 μm, about 50,000 μm to about 100,000 μm, about 100,000 μm to about 200,000 μm, about 200,000 μm to about 300,000 μm, about 300,000 μm to about 400,000 μm, preferably about 1500 μm.

In some embodiments, the step b comprises introducing an oxidising gas to the leaching medium.

In some embodiments, the oxidising gas is oxygen, air or a mixture of air and oxygen.

In some embodiments, the oxidising gas is industrial oxygen.

In some embodiments, the step b takes place in an autoclave.

In some embodiments, the step b takes place in a column or heap.

In some embodiments, the copper-containing material is in the form of a fine powder.

In some embodiments, the step b takes place in an agitated tank.

In some embodiments, the agitated tank is a baffled tank.

In some embodiments, the oxidising gas is introduced with supersonic injectors.

In some embodiments, the oxidising gas is introduced with a sparging device.

In some embodiments, the copper-containing material comprises about 0 to about 10 wt % iron, for example, about 0 to about 1 wt %, about 1 to about 2 wt %, about 2 to about 3 wt %, about 3 to about 4 wt %, about 4 to about 5 wt %, about 5 to about 6 wt %, about 6 to about 7 wt %, about 7 to about 8 wt %, about 8 to about 9 wt %, about 9 to about 10 wt %, about 0 to about 3 wt %, about 1 to about 4 wt %, about 2 to about 5 wt %, about 3 to about 6 wt %, about 4 to about 7 wt %, about 5 to about 8 wt %, about 6 to about 9 wt %, or about 7 to about 10 wt % iron. In some embodiments, the copper-containing material comprises about 0, 1, 2, 3, 4, 5, 6, 7, 8, 9, or 10 wt % iron.

In some embodiments, the copper-containing material comprises about 0 to about 30 wt % tin, for example, about 0 to about 5 wt %, about 5 to about 10 wt %, about 10 to about 15 wt %, about 15 to about 20 wt %, about 20 to about 25 wt %, about 25 to about 30 wt %, about 0 to about 10 wt %, about 5 to about 15 wt %, about 10 to about 20 wt %, about 15 to about 25 wt %, or about 20 to about 30 wt %, tin. In some embodiments, the copper-containing material comprises about 0, 5, 10, 15, 20, 25, or 30 wt % tin.

In some embodiments, the copper-containing material comprises about 0 to about 20 wt % lead, for example, about 0 to about 5 wt %, about 5 to about 10 wt %, about 10 to about 15 wt %, about 15 to about 20 wt %, about 0 to about 10 wt %, about 5 to about 15 wt %, about 10 to about 20 wt % lead. In some embodiments, the copper-containing material comprises about 0, 2, 4, 6, 8, 10, 12, 14, 16, 18, or 20 wt % lead.

In some embodiments, the copper-containing material comprises about 0 to about 20 wt % nickel, for example, about 0 to about 5 wt %, about 5 to about 10 wt %, about 10 to about 15 wt %, about 15 to about 20 wt %, about 0 to about 10 wt %, about 5 to about 15 wt %, about 10 to about 20 wt % nickel. In some embodiments, the copper-containing material comprises about 0, 2, 4, 6, 8, 10, 12, 14, 16, 18, or 20 wt % nickel.

In some embodiments, the copper-containing material comprises about 0 to about 20 wt % antimony, for example, about 0 to about 5 wt %, about 5 to about 10 wt %, about 10 to about 15 wt %, about 15 to about 20 wt %, about 0 to about 10 wt %, about 5 to about 15 wt %, about 10 to about 20 wt % antimony. In some embodiments, the copper-containing material comprises about 0, 2, 4, 6, 8, 10, 12, 14, 16, 18, or 20 wt % antimony.

The skilled person would appreciate that un-leached metals and/or metal-containing compounds may include noble metals, for example silver and gold, and potentially platinum group metals if there are present in the secondary copper source going in to the smelter.

In some embodiments, the copper-containing material comprises one or more precious metals comprising gold, platinum, palladium, rhodium, osmium, iridium, ruthenium and/or silver.

In some embodiments, the copper-containing material comprises:
about 0.2 to about 5 wt % iron;
about 0 to about 15 wt % tin;
about 0 to about 10 wt % lead;
about 0 to about 10% nickel;
about 0 to about 10 wt % antimony;
about 50 to about 99.8 wt % copper; and
one or more precious metals comprising gold, platinum, palladium, rhodium, osmium, iridium, ruthenium and/or silver.

In some embodiments, the leaching medium comprises sulfuric acid solution, hydrochloric acid solution and/or nitric acid solution. The skilled person would understand that the leaching medium may comprise other organic or inorganic acid solutions.

The skilled person would appreciate that using sulfuric acid is advantageous because it is relatively low-cost. Additionally, sulfuric acid ensures that lead (and other selected metals) is precipitated as a sulphate during the leaching process, carrying the precious metals with it.

In some embodiments, the acid solution (for example, sulfuric acid) has a concentration of about 0.01 g/L to about 500 g/L, for example, about 0.01 g/L to about 1 g/L, about 1 g/L to about 10 g/L, about 10 g/L to about 20 g/L, about 20 g/L to about 30 g/L, about 30 g/L to about 40 g/L, about 40 g/L to about 50 g/L, about 50 g/L to about 60 g/L, about 60 g/L to about 70 g/L, about 70 g/L to about 80 g/L, about 80 g/L to about 90 g/L, about 90 g/L to about 100 g/L, about 100 g/L to about 200 g/L, about 200 g/L to about 300 g/L, about 300 g/L to about 400 g/L, about 400 g/L to about 500 g/L.

In some embodiments, the acid solution (for example, sulfuric acid) has a concentration of about 1 g/L to about 150 g/L.

In some embodiments, the acid solution (for example, sulfuric acid) has a concentration of about 12 g/L to about 90 g/L.

In some embodiments, the predetermined period is about 0.5 minutes to 336 hours, for example, about 0.5 minutes to about 1 minute, about 1 minute to about 10 minutes, about 10 minutes to about 20 minutes, about 20 minutes to about 30 minutes, about 30 minutes to about 40 minutes, about 40 minutes to about 50 minutes, about 50 minutes to about 60 minutes, about 1 hour to 5 hours, about 5 hours to about 10 hours, about 10 hours to about 15 hours, about 15 hours to about 20 hours, about 20 hours to about 25 hours, about 25 hours to about 30 hours, about 30 hours to about 35 hours, about 35 hours to about 40 hours, about 40 hours to about 50 hours, about 50 hours to about 60 hours, about 60 hours to about 70 hours, about 70 hours to about 80 hours, about 80 hours to about 90 hours, about 90 hours to about 96 hours, about 96 hours to about 120 hours, about 120 hours to about 150 hours, about 150 hours to about 200 hours, about 200 hours to about 250 hours, about 250 hours to about 300 hours, about 300 hours to about 336 hours.

In some embodiments, the predetermined period is about 30 minutes to 48 hours.

In some embodiments, the predetermined temperature is about 0° C. to 500° C., for example, about 0° C. to about 50° C., about 50° C. to about 75° C., about 75° C. to about 100° C., about 100° C. to about 125° C., about 125° C. to about 150° C., about 150° C. to about 175° C., about 175° C. to about 200° C., about 200° C. to about 225° C., about 225° C. to about 250° C., about 250° C. to about 275° C., about 275° C. to about 300° C., about 300° C. to about 325° C., about 325° C. to about 350° C., about 350° C. to about 375° C., about 375° C. to about 400° C., about 400° C. to about 425° C., about 425° C. to about 450° C., about 450° C. to about 475° C., about 475° C. to about 500° C.

In some embodiments, the predetermined temperature is about 75° C. to about 98° C.

In some embodiments, the predetermined temperature is about 25° C. to about 120° C.

In some embodiments, the predetermined pressure is about 0 atm to about 64 atm, for example, about 0 to about 10 atm, about 10 to about 20 atm, about 20 to about 30 atm, about 30 to about 40 atm, about 40 to about 50 atm, about 50 to about 60 atm, or about 60 to about 64 atm.

In some embodiments, the predetermined pressure is about 0.75 atm to 2.0 atm, or about 0.75 atm to about 1.5 atm, or about 0.5 atm to about 32 atm.

In some embodiments, the leach residue comprises iron(II) sulphate, iron(III) sulphate, tin sulphate, lead sulphate, nickel sulphate, antimony sulphate, copper sulphate, bismuth sulphate, arsenic sulphate, tellurium sulphate, selenium sulphate, manganese sulphate, manganese, antimony, tellurium, selenium bismuth, copper iron, tin, lead, nickel, gold, platinum and/or silver. It may also include hydroxide and oxides of these metal species. The skilled person in the art would understand that other metals, sulphates, hydroxides and oxides which are insoluble in the acidic leach solution can also be present in the leach residue, for example As, Bi, Al, B, Ba, Cd, Ca, Mg, Mn, Cr, Ga, Ge, Hg, K, La, Li, Mg, Sb, Te, Se and Zn.

In some embodiments, the leach residue comprises iron(II) sulphate, iron(III) sulphate, tin sulphate, lead sulphate, antimony sulphate, nickel sulphate, iron, tin, lead, antimony, nickel, gold, platinum and/or silver.

The skilled person would understand that each metal or metal compound in the residue may range from 0 to 100 %. The composition of the leach residue depends on the material being processed. Depending on the feed, it may include lead, a tin/lead mix or it may be lead or tin free.

In some embodiments, the copper-containing leachate solution comprises copper ions at a concentration of about 0.01 g/L to about 1,000 g/L, for example, about 0.01 g/L to about 1 g/L, about 1 g/L to about 10 g/L, about 10 g/L to about 20 g/L, about 20 g/L to about 30 g/L, about 30 g/L to about 40 g/L, about 40 g/L to about 50 g/L, about 50 g/L to about 60 g/L, about 60 g/L to about 70 g/L, about 70 g/L to about 80 g/L, about 80 g/L to about 90 g/L, about 90 g/L to about 100 g/L, about 100 g/L to about 200 g/L, about 200 g/L to about 300 g/L, about 300 g/L to about 400 g/L, about 400 g/L to about 500 g/L, about 500 g/L to about 600 g/L, about 600 g/L to about 700 g/L, about 700 g/L to about 800 g/L, about 800 g/L to about 900 g/L, about 900 g/L to about 1000 g/L.

In some embodiments, the copper-containing leachate solution comprises copper ions at a concentration of about 0.5 g/L to about 150 g/L, or about 15 g/L to about 100 g/L.

In some embodiments, the copper-containing leachate solution comprises copper ions at a concentration of about 30 g/L to about 75 g/L.

In some embodiments, the method further comprises a step of smelting the leach residue to thereby produce a tin, antimony, and/or lead-containing product and a precious metals rich product. Both these products are able to be further processed to produce final refined metals.

In some embodiments, the lead tin and/or antimony-containing product comprises lead, antimony and/or tin oxides, in the form of a solid slag product. The smelting of the residue may potentially require fluxes. These fluxes will report to the slag.

In some embodiments, the lead, tin and/or antimony-containing product comprises lead, tin and antimony oxides. It may include other materials originating from the leach residue or fluxes used in the smelting process.

In some embodiments, the method further comprises a step of refining the smelting residue to thereby produce a precious metal dore comprising gold, platinum, palladium, rhodium, iridium, osmium, ruthenium and/or silver.

In some embodiments, the precious metal dore comprises gold, platinum, palladium, rhodium, iridium, osmium, ruthenium and/or silver at a concentration of about 0 wt % to about 100 wt %. The concentrations of the individual metals will vary with the copper-containing material being smelted.

In some embodiments, the refining step comprises a cupellation process.

In some embodiments, the step b is carried out with a solid content of 0.01 to about 95 wt %, for example, about 0% to about 5%, about 5% to about 10%, about 10% to about 15%, about 15% to about 20%, about 20% to about 25%, about 25% to about 30%, about 30% to about 35%, about 35% to about 40%, about 40% to about 45%, about 45% to about 50%, about 50% to about 55%, about 55% to about 60%, about 60% to about 65%, about 65% to about 70%, about 70% to about 75%, about 75% to about 80%, about 80% to about 85%, about 85% to about 90%, about 90% to about 95%.

In some embodiments, the step b is carried out with a solid content of 0 to 25 wt %.

In some embodiments, copper is recovered from the leachate solution via electrowinning to thereby produce copper cathode.

In some embodiments, copper is recovered from the leachate solution via precipitation to thereby produce copper precipitate.

In some embodiments, the recovered copper has a purity of at least 99%, at least 99.1%, at least 99.2%, at least 99.3%, at least 99.4%, at least 99.5%, at least 99.6%, at least 99.7%, at least 99.8%, at least 99.9%, at least 99.95%, or at least 99.99%.

In some embodiments, the secondary copper material comprises E-waste and/or scrap.

In some embodiments, the secondary copper material comprises materials which contain 0 to 100 wt % copper. Typically, the copper bearing materials contain less than 98 wt % copper.

According to a second aspect of the present invention there is provided copper obtained from the method as described above.

The skilled person would appreciate that the present invention may provide one or more significant advantages and improves in the field and/or in view of the prior art. For example, these advantages may include:
The precious metals contained in the material being processed are decreased, enabling a smaller inventory of material onsite.
The number of steps in the process is reduced.
The amount of metal in stockpiles or being processed in the facility is reduced. This reduces the valuable metals stockpiled onsite, reducing the capital associated with these metals. In addition, this may enable the facility to pay various parties faster. This makes the site more economically competitive.
The capital cost for the secondary smelter is reduced. The current process requires a lot of equipment to produce the final metal products.
The minimum viable size for a facility is significantly reduced. Currently, with the existing process, one would need to be producing at least 100,000 tonnes of copper to be economically viable.

Other aspects of the present invention will become apparent to those ordinarily skilled in the art upon review of the following description of specific embodiments of the invention.

### DEFINITIONS

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”. The examples are not intended to limit the scope of the invention. In what follows, or where otherwise indicated, “%” will mean “weight %”, “ratio” will mean “weight ratio” and “parts” will mean “weight parts”.

The term ‘substantially’ as used herein shall mean comprising more than 50% by weight, where relevant, unless otherwise indicated.

The recitation of a numerical range using endpoints includes all numbers subsumed within that range (e.g., 1 to 5 includes 1, 1.5, 2, 2.75, 3, 3.80, 4, 5, etc.).

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

As used herein, with reference to numbers in a range of numerals, the terms “about,” “approximately” and “substantially” are understood to refer to the range of −10% to +10% of the referenced number, preferably −5% to +5% of the referenced number, more preferably −1 % to +1 % of the referenced number, most preferably −0.1 % to +0.1 % of the referenced number. Moreover, with reference to numerical ranges, these terms should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, from 8 to 10, and so forth.

The prior art referred to herein is fully incorporated herein by reference.

The term “black copper” refers to metallic substance produced by melting and/or processing of metallic (scrap) and/or oxidic copper bearing materials (slag, oxides, ashes). Black copper is composed primarily of copper, contains other residual ferrous and non-ferrous metals and may contain metal oxides and metal sulphides.

The term “dore” refers to a semi-pure alloy of gold, silver and/or platinum.

The term “anode copper” refers to copper materials having at least 98% copper content and less than 3,000 ppm of dissolved oxygen.

The term “raw copper” refers to copper metal containing more than 500 ppm of dissolved oxygen and produced from secondary copper materials

Although exemplary embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

### BRIEF DESCRIPTION OF THE DRAWINGS

Preferred embodiments of the invention will now be described, by way of example only, with reference to the accompanying drawings in which:

FIG. 1 shows a process flowsheet for secondary copper processing incorporating an embodiment of the present invention.

FIG. 2 shows test conditions and solution assays for a leaching trial.

FIG. 3 shows the analysis of the final pregnant leach solution (PLS) for a leaching trial.

FIG. 4 shows the analysis of head sample and final tail for a leaching trial.

FIGS. 5a and 5b show the metal extraction and acid consumption with elapsed time in a leaching trial.

### DESCRIPTION OF A PREFERRED EMBODIMENT

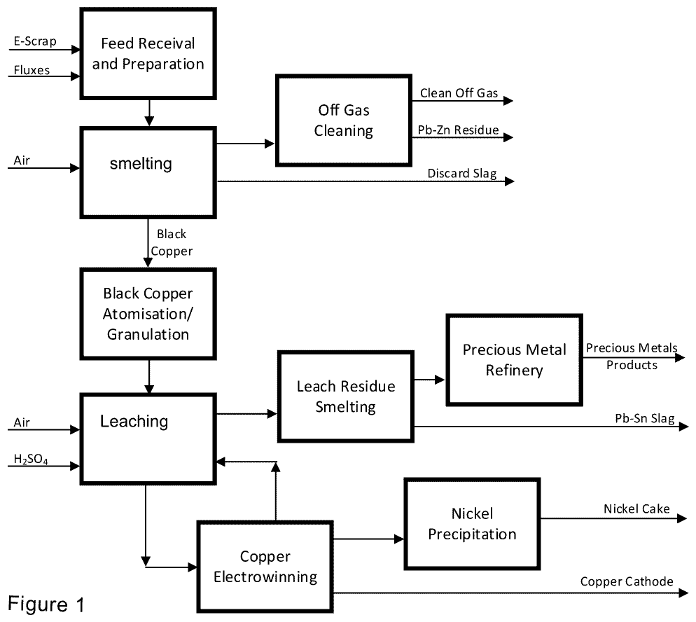

Referring to FIG. 1, E-waste and scrap materials are subjected to a smelting process in a furnace, for example an ISAMELT™ or ISACYCLE™ furnace to produce black copper. The black copper is then subjected to a leaching medium comprising sulfuric acid solution under a flow of air as an oxidising gas. The leachate solution is subjected to an electrowinning process to produce copper cathode. Nickle cake is produced from the electrowinning process after precipitation. The leach residue is subjected to a smelting process to produce a Pb—Sn slag and a smelting product, which is then refined to obtain precious metal products.

The following illustrates results obtained from a trial in relation to leaching of black copper in accordance with an embodiment of the present invention.

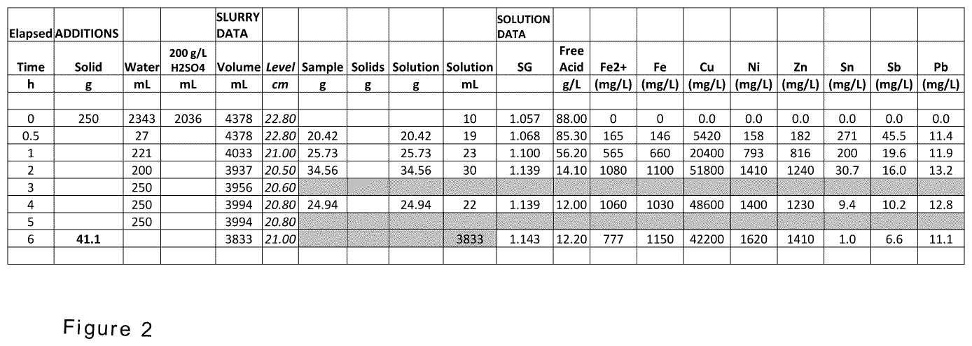

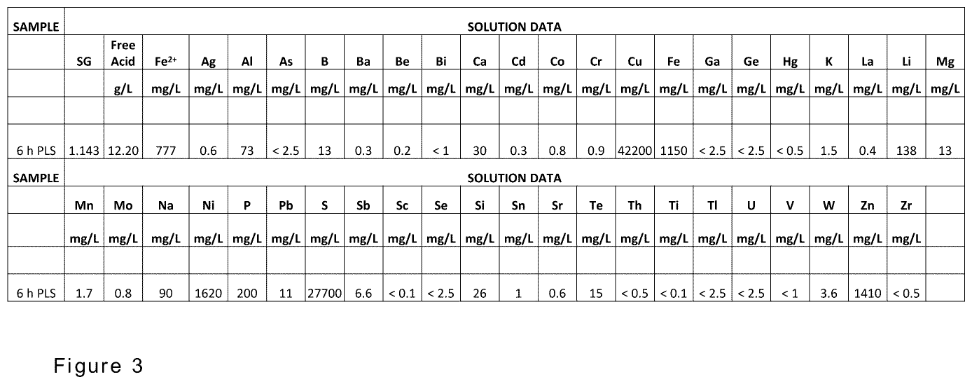

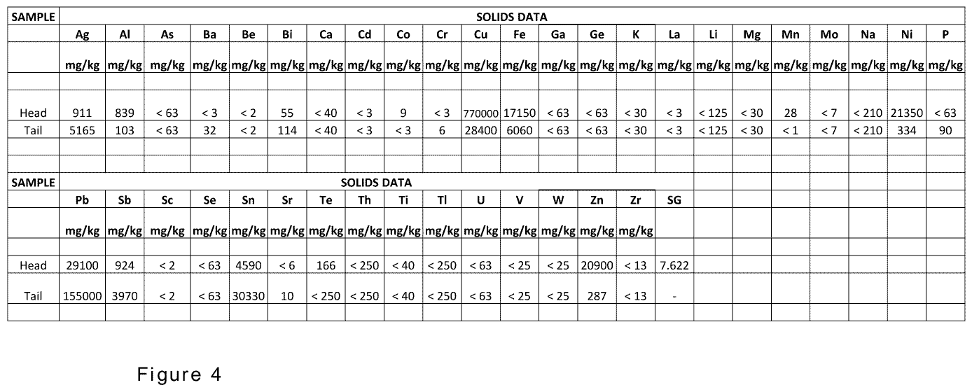

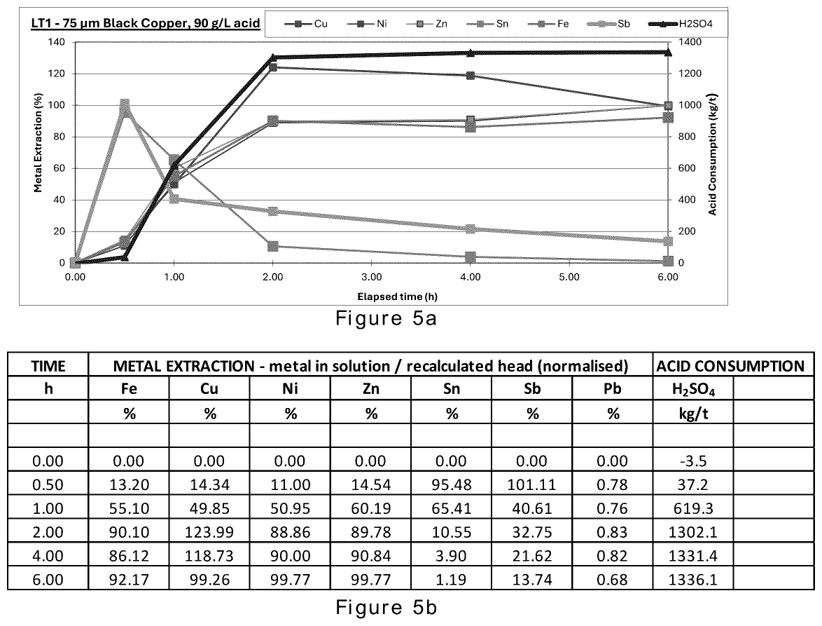

The black copper sample had a particle size P80 of 75 μm. The leaching process took place in an agitated and baffled reactor with a temperature of about 95° C. The test run for about 6 hours and FIG. 2 shows the test conditions and solution assays. FIG. 3 shows the analysis of the final pregnant leach solution (PLS). FIG. 4 shows the analysis of head sample and final tail. FIGS. 5a and 5b show the metal extraction and acid consumption with elapsed time.

### INDUSTRIAL APPLICABILITY

The invention as described above relates to a method for leaching black copper obtained from the smelting of secondary copper materials including E-waste and scrap. The direct leaching of black copper removes the need to perform converting and refining of the copper, which is required in the existing process of secondary copper processing. The leachate solution and the leach residue may be subjected to further processing (for example, electrowinning and/or precipitation) to recover metals including copper, precious metals, Pb—Sn slag and/or nickel. The invention as described thereby demonstrates industrial applicability in the economic value of the copper recovered, and environmental efficacy by remediating otherwise waste materials.

Furthermore, the inventive method provides means for recovering precious metals such as silver, gold and platinum from leach residues.

1. A method of copper leaching, comprising the steps of:
a. obtaining a copper-containing material from the smelting of one or more secondary copper materials;
b. subjecting the copper-containing material to an acidic and oxidising leaching medium over a predetermined period, at a predetermined temperature and a predetermined pressure;
c. obtaining a leach residue comprising un-leached metals and/or metal-containing compounds and a copper-containing leachate solution; and
d. recovering copper from the leachate solution.

2. The method of claim 1, wherein the step b comprises introducing an oxidising gas to the leaching medium.

3. The method of claim 2, wherein the oxidising gas is oxygen, air or a mixture of air and oxygen.

4. The method of claim 2, wherein the oxidising gas is introduced into the leaching reactor with a sparging device.

5. The method of claim 1, wherein the copper-containing material has a P₈₀ particle size of about 5 to about 400,000 μm.

6. The method of claim 1, wherein the copper-containing material comprises about 0 to about 10 wt % iron.

7. The method of claim 1, wherein the copper-containing material comprises about 0 to about 30 wt % tin.

8. The method of claim 1, wherein the copper-containing material comprises about 0 to about 20 wt % lead.

9. The method of claim 1, wherein the copper-containing material comprises about 0 to about 20 wt % nickel.

10. The method of claim 1, wherein the copper-containing material comprises one or more precious metals comprising gold, platinum, palladium, rhodium, osmium, iridium, ruthenium and/or silver.

11. The method of claim 1, wherein the copper-containing material comprises:
about 0.2 to about 5 wt % iron;
about 0 to about 15 wt % tin;
about 0 to about 10 wt % lead;
about 0 to about 10 wt % nickel;
about 0 to about 10 wt % antimony;
about 50 to about 99.8 wt % copper; and
one or more precious metals comprising gold, platinum and/or silver.

12. The method of claim 1, wherein the leaching medium comprises sulfuric acid solution, hydrochloric acid solution and/or nitric acid solution.

13-14. (canceled)

15. The method of claim 1, wherein the predetermined period is about 0.5 minute to about 336 hours, or about 30 minutes to about 48 hours.

16. (canceled)

17. The method of claim 1, wherein the predetermined temperature is about 0° C. to about 500° C., or about 25° C. to about 120° C.

18. (canceled)

19. The method of claim 1, wherein the predetermined pressure is about 0 atm to about 64 atm, or about 0.75 atm to about 1.5 atm.

20-21. (canceled)

22. The method of claim 1, wherein the copper-containing leachate solution comprises copper ions at a concentration of about 0.01 g/L to about 1,000 g/L, or about 15 g/L to about 100 g/L.

23. (canceled)

24. The method of claim 1, wherein the leach residue comprises lead, lead sulphate, tin, tin sulphate and/or precious metals comprising silver, platinum and/or gold and wherein the method further comprises a step of smelting the leach residue to thereby produce a lead, tin and/or antimony-containing product and a precious metals rich product.

25-27. (canceled)

28. The method of claim 1, wherein the step b is carried out with a solid content of 0 to about 95 wt %, or 0 to about 25 wt %.

29. (canceled)

30. The method of claim 1, wherein copper is recovered from the leachate solution via electrowinning to thereby produce copper cathode, or via precipitation to thereby produce copper precipitate.

31-33. (canceled)

34. The method of claim 1, wherein the secondary copper material comprises E-waste and/or scrap.

35. (canceled)
